(19) United States
(12) Patent Application Publication
(10) Pub. No.: US 2006/0138039 A1
(43) Pub. Date: Jun. 29, 2006

(54) Filtering device, filtering means, and filtration method

(76) Inventors: Erhard Rudolf, Linsenbuhlstrasse (DE); Markus Gluck, Gerhart-Hauptmann-Strasse (DE)

Correspondence Address: KAPLAN GILMAN GIBSON & DERNIER L.L.P., 900 ROUTE 9 NORTH, WOODBRIDGE, NJ, 07095, US

(21) Appl. No.: 10/544,590

(22) PCT Filed: Feb. 10, 2004
(86) PCT No.: PCT/DE04/00234

§ 371 Date: Aug. 4, 2005

(30) Foreign Application Priority Data
Feb. 10, 2003 (DE) 103 05 320.4
Jul. 10, 2003 (DE) 103 31 457.1

(51) Int. Cl. B01D 29/62

(52) U.S. Cl. 210/407

(57) ABSTRACT

The Invention concerns a filter device comprising a vessel, at least one suspension feed line and one suspension removal line in each case, at least one filtrate removal line and at least one filtering means disposed in a stationary manner. According to the invention, the at least one suspension feed line is disposed in the vessel wall and/or in the vessel interior, wherein the suspension feed line is disposed such that the suspension can be supplied to the vessel tangentially and the rotating flow of the suspension which is thus produced over the filtering means prevents the surface thereof from clogging. Further, the invention concerns a filtering means. Finally, there is disclosed a filtration method, which is performed in the filter device.

### BACKGROUND

This invention relates to a filter device, a filtering means and a filtration method.

In technical literature, the generic terms “filter devices” and “filter assemblies” designate auxiliary implements in or with which substances dissolved in fluids or gases in any state of aggregation or suspended or cloudy materials in any form can be separated and removed from the solvent.

The fluid to be filtered is designated the “suspension” and the cleaned fluid running through the filter is designated the “filtrate”. The solid material remaining on the filter is called the “residue” and is also designated the “filter cake”.

The “filtering means” designates appropriate auxiliary devices, components, coatings or tools required for the filtration. Various forms of implementation of filtering means are known from all devisable material combinations, plastics, ceramics or precious metals of various porosities and basic structures.

Most frequently used are grain filters (e.g. sand or crushed dusts like activated carbon), filter paper or fabric filters (e.g. cloth, fleeces, textile or wire gauze fabrics), stiff porous filters (e.g. ceramic materials) and semi permeable or permeable membranes (also including, for example, animal hides).

A majority of known implementation forms contain one filtering means or a variety of filtering means in a generally cylindrical vessel, which are composed either of one or more tubular or hollow-fiber individual filters or contain a rod-shaped filter column consisting of several filter plates.

To increase the service life and above all to increase the filter performance, it is known that overflowing the filter surfaces combined with an abrasive removal of the residue leads to an enormous productivity increase—generally known by the term cross-flow technology. Therefore, in previous filter devices for the creation of such an advantageous removal of residues, generally an agitator driven from the outside over rotating mechanical seals through the vessel wall was integrated into the entire device, which, in addition to the advantageous abrasion of the filter cake, also bears significant disadvantages of these filter devices. Thus, for example, filtering means must be integrated into expensive rotating devices, which, in addition to the high mass of the rotor and the filter columns, result in high inertia of the structure itself, high flow resistances in the movement in the fluid to be filtered and, due to inevitable imbalances and vibrations, significant limitations in the cross flow rate, and enormous deficiencies in known filter assemblies. In general, very high energy consumption is extremely disadvantageous. In addition, the main construction difficulty, and the main error source in the event of operating faults, arises from the complex and high-power consuming mechanical motor driven actuation. At the same time, the attainable cross flow rate on the filter surface is limited, which in turn impairs the removal of the filter cake that forms on the filter surface and thus the productivity of the filter device in industrial applications. Such arrangements are, for example, presented in patent specifications DE 41 35 359 or DE 34 01 607.

A particularly disadvantageous feature of any type of revolving assembly to agitate or rinse the filter surfaces is the inherent use of rotating ducts in the system, which are indisputably necessary, cost-intensive and especially characterized by an unfavorable susceptibility to faults during the operation of the filter. Such a design is described in DE 41 35 359.

Filter devices are known from DE 100 38 329 and DE 43 40 218, in which stationary filtering means are combined with agitators. In these devices, the cross flow over the filtering means is achieved through the movement of the agitators.

Furthermore, a filter device is known from U.S. Pat. No. 6,168,724, in which the filtering means are stationary. In this device, the flow of the suspension is generated by the housing, which rotates around the filtering means. Although the maximum surface of the filtering means can be used on this type of filter, the problems of the rotating ducts and the energy consumption for the rotation remain.

Finally, filter devices are known from U.S. Pat. No. 5,500,134 and EP 0 002 422, in which the flow is generated through stationary filtering means by means of the feed of the suspension. In U.S. Pat. No. 5,500,134, this occurs by means of a two-chamber system. The inflow of the suspension first occurs into the external chamber and is then introduced into the inner chamber through a perforated partition wall. In EP 0 002 422, the feed of the suspension occurs through a separate suspension feed line, which is incorporated into the interior of the vessel, preferably in the middle of it. The disadvantage is that both the suspension feed line and the removal line penetrate the filtering means. Therefore, not only are high manufacturing costs incurred as a result of the filtering means design with correspondingly shaped openings, but the feed and removal lines interrupt the flow and behind each pipe, viewed in the flow direction, an area (the so-called “shadow”) develops on the filtering means which is not overflowed and in which particles can consequently be deposited. Standard discs cannot be used. The basic material may become stressed due to the numerous penetrations of the discs for the feed and removal lines. In addition, the discs show a vibration response which deviates from standard discs with a center perforation, with the result that such discs can be destroyed relatively quickly. Furthermore, the assembly of this filter device is very complicated, since the discs of the filtering means must be positioned precisely.

### SUMMARY

In view of the previously explained problems, the object of the invention is to provide an improved filter device, in which a locally strengthened cross flow is generated in any filter surface and filter geometry. In particular, the achieved cross flow should at least be generated over large areas of the filtering means and should prevent “shadow formation”. Overall, the removal of the filter residue accumulating on the filter surface should be improved.

This purpose is achieved by a filter device according to claim 1, a filtering means according to claim 22 and a filtration method according to claim 25. Advantageous embodiments of the invention are the subject of the dependent claims.

The filter device, according to the invention, consists of a single or multipart vessel, at least one suspension feed line and one suspension removal line respectively, at least one filtrate removal line and at least one stationary filtering means. It is intended that the suspension feed line is disposed in the vessel wall and/or the vessel interior, the purpose of such an arrangement being that the suspension can be fed into the vessel tangentially. In other words, it is fed parallel or at an angle to the surface of the filtering means, with the angle deviating from 90° to the vessel wall. The apertures of the suspension feed line are located tangentially, so that the filtering means are cross flowed tangentially, i.e. obliquely. The removal of the suspension therefore does not occur perpendicular to the vessel wall at the point where the aperture begins, but at an angle deviating from the perpendicular. In other words, the term “tangential” is understood to mean an arrangement of the apertures and an inflow direction of the suspension, which can be described in more detail with the aid of a tangent. If one regards a circuit as the vessel wall or the wall of the central tube, then the boreholes, which at these intersecting points can be placed following the course of the tangent, are tangentially located. Due to the oblique feed, the suspension activates a circular movement, a rotating flow, over the filtering means. The suspension feed line can be located in the vessel wall according to the invention; the suspension then flows into the interior of the vessel accordingly from the circumference of the vessel. However, the suspension feed line can also be located in the interior of the vessel, not only centrally but also eccentrically. In addition, a filter device according to the invention, can have one or more suspension feed lines in the vessel wall and also one or more suspension feed lines in the interior of the vessel. This arrangement is particularly advantageous, for example, in filter assemblies with very large diameters, since due to the inflow of the suspension, both from the outside and also from the inside, the entire filter cross-section and thus the entire surface of the filtering means is cross flowed tangentially. This largely prevents shadow formation.

The suspension is located in a flowing state in the layers, surfaces or spaces between the filtering means, which are preferably disc-shaped. The suspension is in motion, whereby the motion has a primary flowing direction, which may include turbulence and other superimposed flows.

Due to the stationary arrangement of the filtering means, and since no rotating vessel parts or agitators are necessary to generate a flow, the filter device, according to the invention, dispenses with all of the rotating ducts which have shown themselves to be disadvantageous in day-to-day use. Furthermore, this results in a significant improvement in the energy balance. The flow of the suspension in the interior of the vessel is also not obstructed. This eliminates not only the so-called shadow areas, in which particles can accumulate, but also the flow can spread and expand unhindered over the filtering means and contribute to the desired abrasion of the filter cake. Due to the predominant absence of corners and edges, an improved sterilization capability of the filter device also occurs, so that, for example, steam sterilization procedures can also be used. Preferably, standard filtering means discs can be used in the filter device, in particular ceramic hollow filter discs. Preferably, a center tube is incorporated, in which the filtrate removal line and/or the suspension feed line and/or the suspension removal line are incorporated. The components which are not located in the central tube are formed in the vessel wall. It thus advantageously arises that no further perforations, except for the usual aperture in the middle of a filter disc, must be formed in the filtering means.

The filtering means, according to the invention, consists of an inner elementary body, by means of which a filtrate is drained into a filtrate removal line, above which a sieve or membrane is attached, through which the filtration process occurs. The surface of the filtering means is at least partially profiled and/or the edge of the filtering means is at least partially profiled, whereby the edge in particular is profiled in an undulated shape.

The filtration method, according to the invention, is performed in a vessel having at least one suspension feed line and one suspension removal line respectively, at least one filtrate removal line and at least one stationary filtering means. As a new feature, the suspension flows in tangentially, under pressure, through the suspension feed line located in the vessel wall. The filtration method, according to the invention, reliably eliminates deposits on the filtering means, without requiring high energy consumption.

The filter device, according to the invention, preferably has a modular construction. It consists of individual filter modules, whereby each filter module has at least one suspension feed line, one suspension removal line, one filtering means and one filtrate removal line. The advantage of the modular construction is that any number of filter modules can be combined into the filter device according to the invention. This means that filters of different sizes and output classes can be combined.

The filter device and filtration method, according to the invention, also show a number of characteristics that are desirable for use especially in production, and in food industries, a selection of which are briefly summarized as follows:
High flexibility and short downtimes, among other things are possible, based on the use of different filtering means, filter materials and implementation forms;
Little effort is required in regeneration or cleaning and therefore repeated use of the filtering means, e.g. a rapidly and automatically backwashing of the residue from the filter surface is possible. Sterilization processes using hot steam or water are also possible, and a reduced use of chemical solutions is required in any acid-based or lye-based cleaning steps;
Low susceptibility to failures, low maintenance requirements and a maintenance-friendly design to achieve short set-up times and possibly long service intervals.

### BRIEF DESCRIPTION OF THE FIGURES

For the practical implementation of the invention, several implementation forms can be conceived, all of which are characterized by a stationary implementation of the auxiliary filtering means driven by cross flow technology. In the following section, the invention is explained in more detail by means of embodiments with reference to the schematic drawings in the following FIGS.

It is shown:

FIG. 1: a partially sectional perspective drawing of a filter device according to the invention;

FIG. 2: a longitudinal section through an additional embodiment of a filter device;

FIG. 3: a perspective view of the filter device in FIG. 2;

FIG. 4: a plan view of the filter device of FIGS. 2 and 3;

FIG. 5: a partially sectional perspective drawing of another embodiment of a filter device according to the invention;

FIG. 6: a cross-section through still another embodiment of the invention;

FIG. 7: a plan view of a filtering means according to the invention;

FIG. 8: a cross-section through still another embodiment of a filter device;

FIG. 9: a longitudinal section through still another embodiment of a filter device;

FIG. 10: a longitudinal section through still another embodiment of a filter device;

FIG. 11: a plan view of the filter device in FIG. 10;

FIG. 12: a partially sectional perspective drawing of a further embodiment of a filter device according to the invention;

FIG. 13: a functional representation of still another embodiment of the invention; and

FIG. 14: a section along line A-A in FIG. 13.

### DETAILED DESCRIPTION

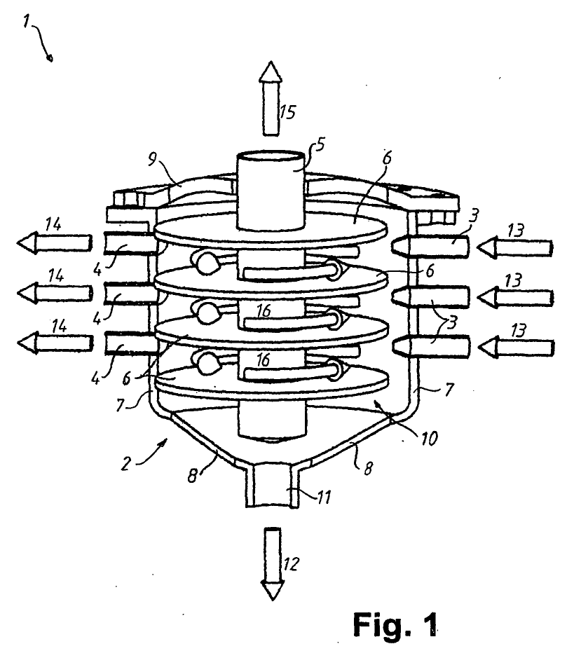

As can be seen in FIG. 1, the filter device 1 according to the invention consists of a vessel 2, in the vessel wall 7 of which several suspension feed lines 3 and suspension removal lines 4 are located. From the illustration, it is clear that the cross-section of the suspension feed lines 3 tapers towards the interior of the vessel 10, whereas the cross-section of the suspension removal lines 4 remains constant or widens. In the vessel interior 10, a number of disc-shaped filtering means 6 are located. The filtering means are located along a longitudinal axis of the vessel 2, which coincides with the filtrate removal line 5 in the embodiment of FIG. 1. The suspension feed line is shown by arrows 13, its removal line by arrows 14 and the outflow of the filtrate by arrow 15. In addition, the vessel has a vessel lid 9, which delimits the vessel 2 in the upwards direction, and a vessel bottom 8, which delimits the vessel in the downwards direction. The vessel bottom 8 is funnel-shaped in the embodiment of FIG. I and equipped with a particle removal 11. The inflow of the suspension through the suspension feed lines 3 occurs tangentially. In other words, the inflow does not occur perpendicular to the vessel wall 7, but deviating from it at an angle, or so called obliquely. Thus the suspension is accelerated over every filtering means 6 and performs a circular movement within, as indicated by the arrows 16. It becomes apparent that every filtering means 6 is assigned to at least one suspension feed line 3, over the surface of which the suspension is moved. By means of the flow of the suspension over the filtering means 6, its surface is kept free of particles. Furthermore, a centrifugal effect occurs whereby in particular, larger particles are drawn towards the perimeter area of the filtering means 6, and at the vessel wall 7 sink to the vessel bottom 8 and can thus be removed through the particle removal 11, indicated by the arrow 12 (cyclonic effect). A floating separation therefore occurs as a result of the rotating movements of the suspension to be filtered over the surface of the filtering means and the thus active centrifugal forces, which in turn leads to the evacuation of loosened or dissolved filtering residues and suspended matter. These are directed into an area where they can either be concentrated or locally suctioned off and do not immediately lead to the congestion of the filter surfaces, for example if they can flow into the edge areas or into a retention area in the vessel, in the embodiment the vessel bottom 8, which would contribute to a significant increase in the operating life. The use of inlet devices consisting of one or more nozzles, the suspension feed lines 3, due to the considerably reduced cross-section of typically a few millimeters, leads to increased flow rates and—by including special designs (e.g. a spin)—to a significantly improved removal of filter residues on the filter surface by means of abrasion. The cross flow velocity thus reaches many times the speed that would otherwise be reached with agitators, specifically by the use of Venturi nozzles. The suspension feed lines 3 can consist of one or several individual nozzles or can consist of configurations of several nozzles (e.g. swiveling or quasi-stationary comb structures). They are located punctiformly at different positions of the vessel 2 and can, if necessary, be addressed by different pressures, diameters and flow rates to influence and increase the flow form and cross flow rates on the surface of the filtering means in a calculated manner. The suspension is filtered by the filtering means 6 to the filtrate removal line 5. It should be noted that the filtrate removal line 5 can also proceed through the vessel bottom 8 or the vessel wall 7, not only through the vessel lid 9 as shown. In the embodiment of FIG. 1, in the interests of greater presentability, only a few filtering means 6 and their associated suspension feed lines 3 and removal lines 4 are shown. However, merely depending on the desired filter output and the spatial circumstances, an almost discretionary number of filtering means 6 can be located on top of each other and the suspension feed and removal lines 3, 4 assigned accordingly. Furthermore, several stacks of filtering means may also be located within one housing. In FIG. 1, only one suspension feed line 3 and one corresponding suspension removal line 4 per filtering means are shown. However, a provision is made for the fact that multiple pipes are distributed horizontally and almost evenly over the vessel wall 7. By providing several, in particular two to fifty such suspension feed lines 3 per filtering means 6, an effective cross flow of the filtering means 6 is achieved. If these pipes are uniformly distributed over the full extent of the vessel 2, this effect is further enhanced. Furthermore, the suspension feed lines 3 assigned to a filtering means 6 can be located at various heights, whereby the inflow of the suspension is varied, which further improves abrasion of the particles (see FIG. 9). Generally speaking, the filter is arranged so that two degrees of freedom—pressure and flow rate—are available as independent, freely configurable parameters, so as to influence both the filter output and the degree of residue removal (so-called abrasion) of the filter surface by means of a “cross-flow”. The influence parameters are set by means of the flow rate and the pressure conditions in the vessel 2, as well as in the suspension feed and removal lines. The filtration method may be extended by additional regeneration or cleaning steps, respectively. Thus, by means of pulsating the flow rate, pulse-type air admixture, ultrasound or other mechanical means of inducing vibration in parts of the filter device I or the complete assembly (e.g. vibrating bearings, vibrating units, oscillators, imbalances, eccentric tappets, etc.) an improvement of the abrasion can be achieved.

By means of FIG. 1, an additional embodiment of the invention is described. The filter device I according to the invention can have appropriately sized rotation bodies between the individual filtering means 6. These rotation bodies are floating objects, which for example take the form of discs, rings, balls, pyramids or rectangular prisms. They are moved with the flow and, due to their rolling friction or the cross-sectional taper caused by them, lead to locally increased cross flow rates on the filter surface and improved abrasion of the filter residue of the filter surface.

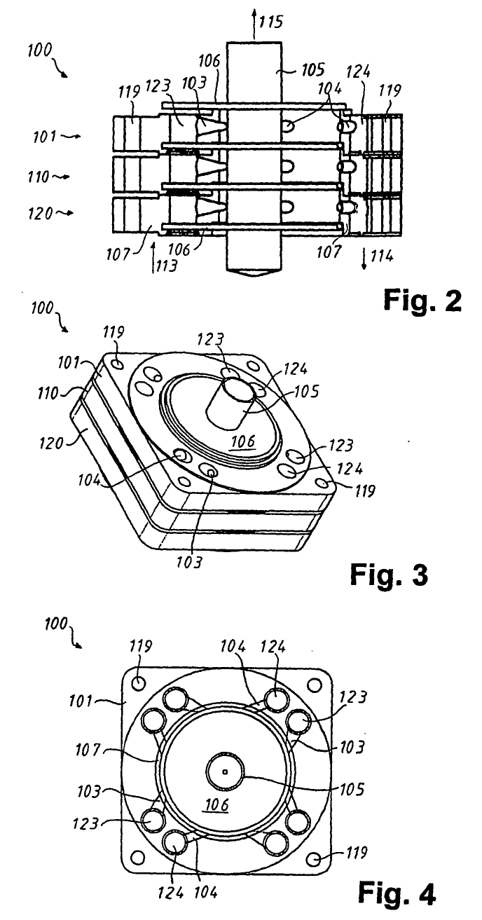

FIGS. 2 to 4 show another embodiment of the invention. Filter device 100 is a filter device of a modular construction. Thus individual filter device modules are located on top of each other, or behind each other, so that they form a so-called column. This is advantageous, since the filter device can be expanded and its filtration performance can therefore be increased by simply adding one or more additional modules without the need for more extensive conversion measures or even the replacement of the entire filter device by one with a higher filtration performance. Naturally, the same also applies when downsizing the filter device. In the embodiment of FIGS. 2 to 4, three filter modules 101, 110, 120 are arranged, one behind the other. Each individual filter module 101, 110, 120 respectively contains a filtering means 106. The filtrate is removed through the filtrate removal line 105, indicated by the arrow 115. Furthermore, for each filter module 101, 110, 120, separate suspension feed lines 103 and suspension removal lines 104 are provided. Therefore, as shown in FIG. 1, either one suspension feed and removal line only, or a large number of them can be provided for each filter module. Each suspension feed line 103 and each suspension removal line 104 empties into a suspension collection feed line 123 or a suspension collection removal line 124, by means of which the suspension is centrally fed to the filter module 101, 110, 120 (arrow 113) or drained off (arrow 114), respectively. By successively arranging multiple filter modules 101, 110, 120, the suspension collection pipes 123, 124 are located on top of each other, and the suspension is fed through them to the filter device 100. To seal the collection lines, gaskets (not shown) can be used. In the embodiment in FIG. 2 to 4, only one filtering means 106 per filter module 101, 110, 120 is provided. However, several filtering means 106 can also be combined in one module. In principle, units of filtering means 106 are joined together by the modular construction, which can then be located with other modules into a filter device 100. Such a unit, for example, could comprise a 1 m² filter surface. Furthermore, for example, modules can also be arranged in a row, and the filtering means of such modules can have different filtration characteristics, such as a different pore size. The filtrates of the individual modules can then be fed to the closest related module as a suspension, and a large number of filtration steps can be performed in an individual filter device. The filtering means 106 can be attached to each filter module 101, 110, 120 over the filtrate removal line 105, similar to the filter device 1 in FIG. 1. In deviation from this, it is intended that the filtering means 106 are alternatively or additionally attached in the vessel wall 107. This is advantageous, if filtering means 106 with a comparatively large diameter must be used. By attaching the filtering means 106 in the edge area, a vibration of the filtering means 106 in use, i.e. during the filtration process, is prevented or reduced, which reduces the risk of breaking of the filtering means 106, which is of particular importance in ceramic filters. If necessary, another gasket (not shown) is provided for such an attachment, to guarantee the sealing of the modules against each other. The filter modules 101, 110, 120 are linked to one another by means of a screw joint 119 or similar fastener. In the illustration in FIG. 4, an embodiment of an arrangement of suspension feed lines 103 and suspension removal lines 104 is shown. It is clear, that they are tangentially located, so that both the inflow and also the outflow of the suspension occur tangentially. All suspension feed lines 103 and suspension removal lines 104 are equally aligned in FIG. 4, i.e. the suspension feed lines 103 are aligned left-hand tangentially, and the inflow therefore occurs in a clockwise direction, and the suspension removal lines 104 are aligned right-hand tangentially, so that the outflow of the suspension occurs in counter-clockwise direction. It is however intended that both the suspension feed lines 103 and also the suspension removal lines 104 are identically aligned, i.e. for example both in the clockwise direction or both in the counter-clockwise direction. Furthermore, it is intended that the suspension feed lines 103 and/or suspension removal lines 104 are aligned variably one below the other. Thus, for example, each second suspension feed line 103 and/or suspension removal line 104 can be aligned left-hand tangentially and the remaining ones right-hand tangentially.

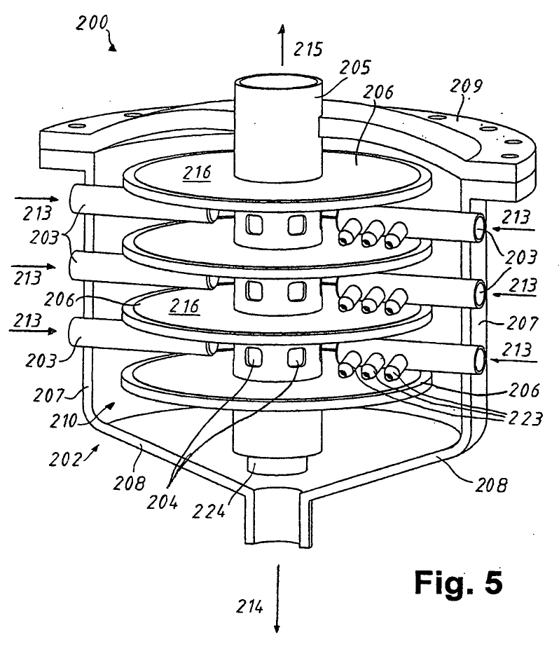

In FIG. 5, another embodiment of a filter device 200 is shown in a perspective, partially sectional illustration. The filter device 200 has a vessel 202, which consists of the vessel wall 207, the vessel lid 209 and the vessel bottom 208. In the vessel wall 207, suspension feed lines 203 are located (arrow 213). The suspension feed lines 203 reach into the vessel interior 210, between the filtering means 206. There they flow the suspension over nozzles 223 onto the surfaces 216 of the filtering means 206. The filtering means 206, as in all other embodiments of the invention, have a stationary arrangement. Each suspension feed line 203 can be equipped with several or even only one nozzle 223; in the embodiment in FIG. 5, there are three nozzles. The suspension feed lines 203 can thus have a stationary or swiveling or rotating design. Since the suspension is flowed in over the filtering means 206, a flow is generated on its surface 216, which is continued there and prevents the deposition of particles and removes deposited particles, respectively, thus preventing the formation of a filter cake. Here too, the suspension inflow occurs tangentially. The suspension is not applied perpendicularly on the filtering means 206, but rather obliquely, as is clearly apparent from FIG. 5. The tangential inflow ensures that the flow on the filtering means 206 continues and thus performs the desired abrasion over a specific surface. The outflow of the suspension (arrow 214) occurs via the axis of the vessel 202. Not only the filtrate removal line 205 (arrow 215) is located there, but also the suspension removal line. In the area of filtering means, numerous suspension removal lines 204 empty into the central suspension collection removal line 224. As in the embodiments in FIG. 1 to 4, the filter device 200 for each filtering means 206 possesses several suspension feed and removal lines, which in particular are evenly distributed over the surface of the vessel 202 or its axis.

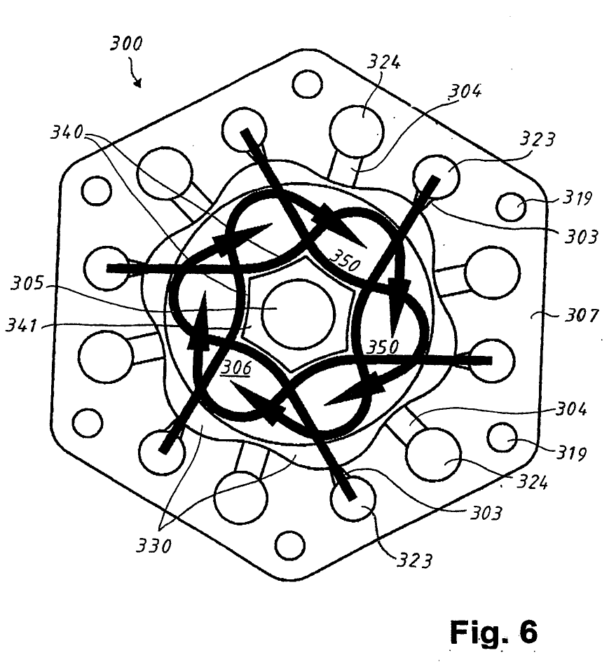

FIG. 6 shows a section through a filter device 300 and a plan view of it. It possesses a vessel, in which at least one filtering means 306 is located. In the vessel wall 307, suspension feed lines 303 and suspension removal lines 304 are located, which respectively empty into suspension collection feed lines 323 and removal lines 324, respectively. For the removal of the filtrate, a filtrate removal line 305 is provided. The vessel wall 307 has several indentations 330. These are rounded and their number is discretionary. The suspension feed lines 303 are preferably located in the area of that indentation 330 which is furthest away from the filtrate removal line 305, on the waist, as it were, of the indentation 330. On the other hand, the suspension removal lines 304 are preferably located where the indentation 330 is closest to the filtrate removal line 305. In addition to the indentations 330 on the vessel wall 307, indentations 340 on the central tube 341 are also provided. The “waists” of the indentations 340 are preferably almost opposite the “waists” of the indentations 330, whereby a slight displacement to each other has proved to be advantageous regarding the flow of the suspension. The indentations 330 and 340 contribute to the improvement of the flow on the filtering means 306 and thus in the vessel interior. The flow 350 caused by the suspension feed lines 303 is shown by the arrows. Each suspension feed line 303 fulfils a dual function, firstly feeding new suspension into the vessel and secondly accelerating the suspension already inside the vessel. From the flow diagram in FIG. 6, it transpires that the filtering means 306 has a large surface area and is cross flowed over both the internal and external areas of the filtering means 306. The abrasive characteristics of the filter device, according to the invention are therefore further improved as a result of the advantageous vessel geometry. The indentations 330 and 340 can also be appropriately designated as waves, dents or protrusions. They are therefore local, shell-shaped concavities which can stretch over sections of the vessel wall 307 or the central tube 341. They are therefore rounded, trough-shaped or even circular depressions located in the vessel wall 307 and/or the central tube 341. The surface structure of the vessel wall 307 and the central tube 341 therefore resembles the surface of a golf ball with a large number of dimples. On the other hand, the indentations 330 and 340 can also extend over larger areas of the vessel wall 307 and central tube 341, in which case a vertical expansion is preferable. The indentations are then shaped more like grooves, so that the surface of the inner vessel wall resembles the surface of a washboard. If a modular construction is used, individual modules can be linked by means of the boreholes 319.

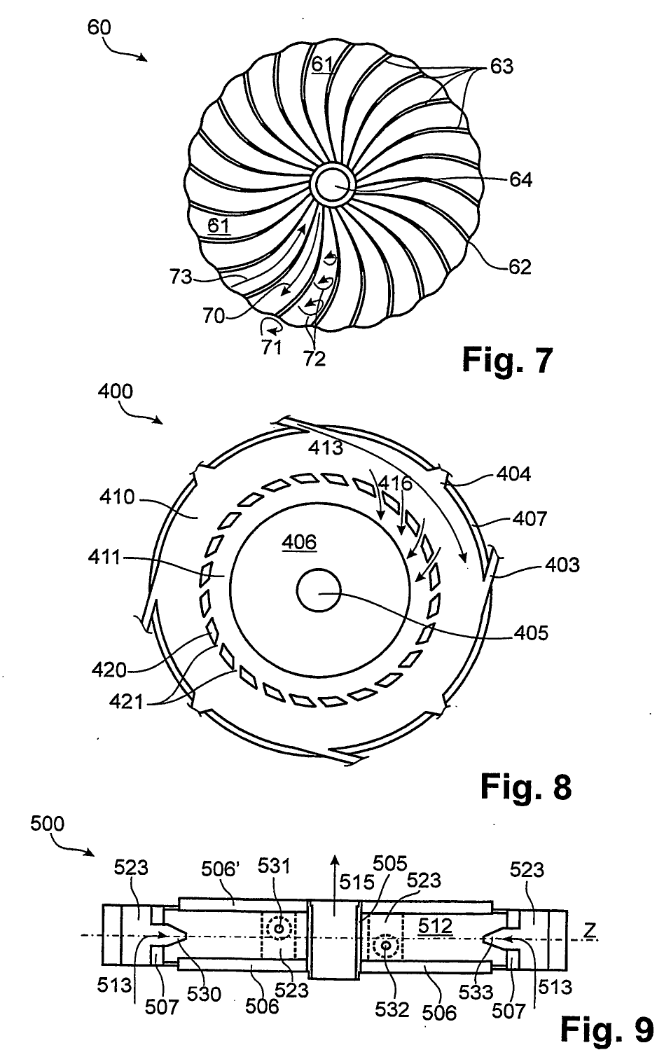

FIG. 7 shows an embodiment of a filtering means 60 according to the invention. The filtering means 60 is a disc-shaped filtering means in the form of a round disc. The filtering means 60 has a surface 61 and an edge 62. According to the invention, the surface 61 is equipped with profiles or fluting 63. This fluting 63 runs from the center 64 to the edge 62 of the filtering means 60, or the other way around. The suspension is thus guided over the surface 61 of the filtering means 60. The fluting 63 is therefore designed so that it can be used to control the flow. Depending on the direction of the inflow, the flow is guided over the surface, either in a direction from the center 64 to the edge 62 or vice versa. In FIG. 7, both flow directions are shown by the flow arrows 70 and 73. In the fluting manner shown in FIG. 7, an inflow in clockwise direction leads to a flow from the center 64 to the edge 62 (arrow 70), and in the filter device therefore from the middle of the vessel to the vessel wall. If, on the other hand, the inflow occurs tangentially in the counter-clockwise direction, then this results in a flow from the edge 62 towards the centre 64 (arrow 73), which therefore causes a flow in the filter device from the vessel wall to the middle of the vessel. Moreover, the fluting 63 on the surface 61 causes turbulences, shown by the arrows 72. These “micro flows” on the surface 61 of the filtering means 60 promote the removal of particles. The filtering means 60, in addition to the fluting of the surface 61, also has a profiled edge 62. The edge 62 is wavy, and possesses swellings and indentations accordingly. This fluting also causes turbulence in the suspension, shown by the arrow 71. This also leads to an improvement in the particle abrasion. The fluting of the surface 61 and the edge 62 can be provided either cumulatively or alternately. Furthermore, both the entire surface 61 and/or the entire edge 62 can be profiled, and/or only partial sections of it. The fluting may, for example, have the form of a corrugated surface, structural patterns (e.g. prism-shaped or dent-shaped embossing or depressions), or helical or arbitrarily arranged grooves. They lead to localized flows and intensified abrasion and thus a targeted, spatially controllable increase in the cross flows, and permit the removal of the filter cake from the filter surface. The filtering means 60 is embodied as a rotationally symmetrical round disc. The fluting of the surface, however, may also be provide on other filtering means, for example, on disc-shaped filtering means of other types, e.g. cassette-shaped and also cylindrical filtering means. The filtering means 60 is preferably a ceramic filter, composite material filter, in particular made from plastic, or a metal fiber filter. In particular, innovative filtering means can also be used, e.g. vitreous materials or metals, which are endowed with a foam like structure by means of special processing. Furthermore, the use of innovative filtering means is envisioned, in which micromechanical porosity is achieved by means of appropriate processing of an otherwise impermeable material or component, e.g. specific micro perforation of thin stainless-steel foils, ion bombardment or plasma treatment of thin membranes, etc. The use of hollow ceramic filter discs, which possess a considerably improved heat resistance, is preferable. This results in a substantially simplified possibility of cleaning or regenerating the filtering means, for example with steam, hot or reactive gases, other mixtures or by means of pyrolysis via the controlled combustion of inorganic or organic filter residues. In addition, it becomes possible to achieve sterilization, which is absolutely necessary in the food and healthcare industries. Moreover, the temperature stability permits the filtration of a hot filtration material. Furthermore, ceramic filters have the advantage that backwashing becomes possible. In this way, the filtrate or suspension is fed back through the filtrate removal line to the vessel, the flow direction effectively being reversed. Such a backwashing step can be integrated into the filtration process as a special washing step. Ceramic filters thus permit the use of relatively high pressures, resulting in a significantly more efficient and faster free washing or backwashing of the filter assemblies. Filtering means according to the invention generally have an internal carrier, in which the propagation of the filtrate towards the filtrate removal line occurs, with a membrane above it, the pore size of which determines the filtration, so-called hollow filter discs. The filtering means 60 can be domed in a conical or bulging shape. Thus, for example, the surface 61 can be convex or concave.

FIG. 8 shows another embodiment of a filter device 400 according to the invention. The filter device 400 also has a vessel, of which only the vessel wall 407 is depicted in FIG. 8. The inflow and outflow of suspension occurs via the suspension feed lines 403 and suspension removal lines 404, respectively, which are located in the vessel wall 407. The inflow thus occurs tangentially in a clockwise or counter-clockwise direction, making gravity separation possible. Moreover, the filter device 400 has at least one centrally located filtering means 406. The filtrate is removed through the filtrate removal line 405. The vessel of the filtration device 400 now includes two vessel compartments 410, 411. These form chambers, which are separated from each other by the partition 420. In the partition 420 are provided perforations 421, by means of which the two vessel compartments 410, 411 are joined to each other. These perforations 421 may have different shapes. They can therefore be simple openings, they can run obliquely, as in the embodiment of FIG. 8, and they can also vary within a partition 420. Within the filter device 400, two kinds of flow cycles are now generated, a primary cycle and a secondary cycle. The suspension which flows in through the suspension feed lines 403 will first move in a circular path in the vessel compartment 410 and form the so-called primary cycle indicated by the arrow 413. However, the suspension is partially diverted by the perforations 421 in the partition 420 and guided into the vessel compartment 411, shown by the arrows 416 and designated as secondary cycle. Here the flow reaches the filtering means 406, where it continues and protects the filtering means 406 against the accumulation of particles. The advantageous aspect is that, the larger particles are separated by the centrifugal effect of the tangentially inflowing suspension in the primary cycle. The separated particles are moved in the direction of the vessel bottom, where they can be released by means of a bleed valve. The larger particles therefore do not even reach the filtering means 406, but rather are already separated out at an earlier stage. As an alternative to a partition 420 with perforations 421, deflectors can also be provided which cause a separation of the flow into two circuits and guide the flow onto the filtering means. In the embodiment in FIG. 8, it can be useful that the filter device 400 only has one suspension feed and removal line each, since the suspension is uniformly distributed by the guidance of the flow as a primary and secondary cycle in the vessel, and a pressure increase occurs by passing it through the perforations 421 into the vessel compartment 411, whereby the suspension experiences an acceleration.

FIG. 9 shows a systematic illustration of a longitudinal section through another embodiment of a filter device 500, according to the invention, in modular form. As already indicated in the remarks for FIG. 1, it is anticipated that at least the suspension feed lines, but also the suspension removal lines, can be located at various heights, or in other words at various levels around the circumference of the vessel. In FIG. 9, an embodiment of such a filter device is shown. For the sake of greater presentability, only the suspension feed lines 530, 531, 532 and 533 have been illustrated; the suspension removal lines are not shown. However, they can be designed in a customary way, i.e. as described in the remaining Figs., and can also be relocated similar to the suspension feed lines 530-533. Moreover, in FIG. 9, only one module is shown, including a filtering means 506, vessel wall 507, suspension collection feed lines 523, suspension feed lines 530-533 and filtrate removal line 505. In addition, the filtering means 506′ of the module is also shown, which is located above the one shown. In the vessel wall 507, distributed around the circumference of the vessel, there are several suspension feed lines 530-533. These are located in relation to each other at different heights of the vessel. The suspension feed lines 530 and 533 are at roughly the same height, indicated by the dashed and dotted line Z. On the other contrary, the suspension feed line 531 is located somewhat above this level and the suspension feed line 532 somewhat below it. The suspension is first fed into the suspension collection feed lines 523 (arrows 513), from where it is fed through the suspension feed lines 530-533 to the interior of the vessel, where it flows over the filtering means 506 and over the lower side of the filtering means 506′. The inner vessel wall 512 can also be structured as the axis of the filtrate removal line 505, as described in FIG. 6. The removal of the filtrate is shown by the arrow 515. Since the sectional illustration provides a plan view of the inner vessel wall 512, the suspension collection feed lines 523 of the suspension feed lines 531 and 532 are shown as dashed lines. They are located in or behind the vessel wall 507. The same applies to the suspension feed lines 531 and 532 with only their outlets visible, and a reduced cross-section in comparison to the feed line (see suspension feed lines 530, 533), and the remainder is also shown in a dashed line.

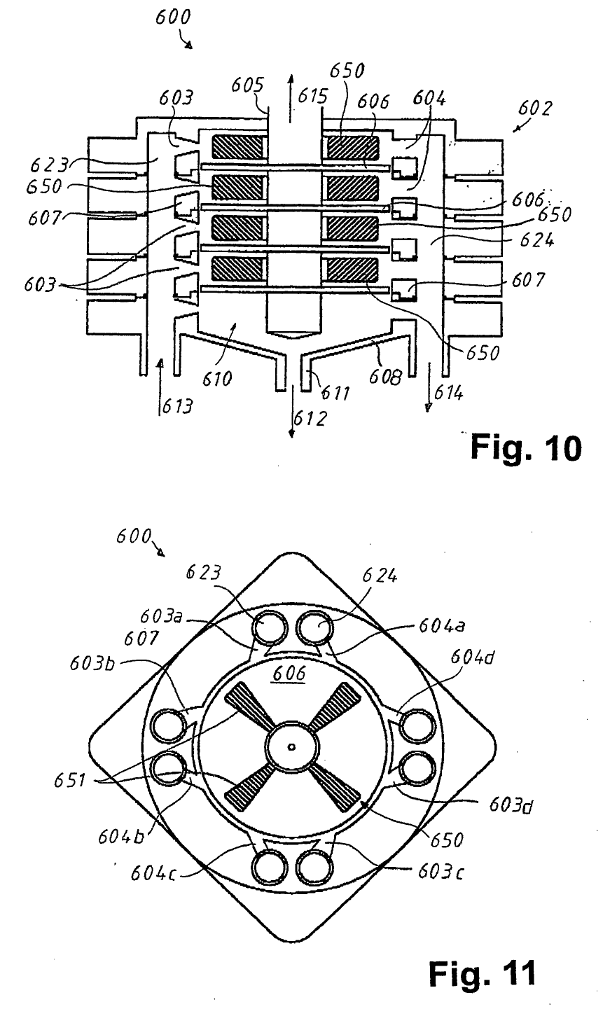

FIGS. 10 and 11 show another embodiment of the invention. The filter device 600 has a number of filtering means 606. The filtrate is discharged through the filtrate removal line 605, indicated by the arrow 615. Furthermore, each filtering means 606 is assigned to suspension feed lines 603 and suspension removal lines 604. Each suspension feed line 603 and each suspension removal line 604 empties into a suspension collection feed line 623 or a suspension collection removal line 624, respectively, through which the suspension is fed into (arrow 613) or drained off from (arrow 614) the filter device 600. The filtering means 606 can be attached by means of the filtrate removal line 605, i.e. centrally mounted. Deviating from this, it is intended that the filtering means 606 are alternatively or additionally fixed in the vessel wall 607. In the illustration in FIG. 11, an embodiment of an arrangement of suspension feed lines 603 and suspension removal lines 604 is shown. It becomes clear, that these are tangentially arranged, so that both the inflow and also the outflow of the suspension occur tangentially. The suspension feed lines 603 and suspension removal lines 604 are variably aligned in FIG. 11. The suspension feed lines 603a and 603c are identically, in fact left-hand tangentially orientated, and the inflow therefore occurs in the counter-clockwise direction. The suspension feed lines 603b and 603d, on the other hand, are right-hand tangentially orientated, so that the inflow occurs in clockwise direction. The same applies to the suspension removal lines 604a and 604c, which are right-hand tangentially aligned, whereas the suspension removal lines 604b and 604d are located left-hand tangentially. It is however also intended that both the suspension feed lines 603 and also the suspension removal lines 604 are identically orientated, i.e. for example both in the clockwise direction or both in the counter-clockwise direction. Furthermore, it is intended that the suspension feed lines 603a-d and/or suspension removal lines 604a-d are orientated identical, but vary in their orientation to each other. Thus, for example, all of the suspension feed lines 603a-d can be orientated left-hand tangentially and the suspension removal lines 604a-d can be orientated right-hand tangentially. It is anticipated that the filter device 600 should have an agitator member 650, which is shown hatched in FIGS. 10 and 11. The agitator member 650 is driven by the flow, which is generated by the tangential inflow. Thus the surface of the filtering means 606 is freed of deposits, which prevents the formation of a filter cake. Similar to the rotating elements described in FIG. 1, the agitator member 650 is moved over the filtering means 606 and driven by means of the flow of the suspension, also, thus its movements are passive, in contrast to the state of the art agitator members. The agitator member 650 can have various embodiments, so it can be shaped like a blade, as shown in FIG. 11, or like a brush or a strip. Furthermore, the number of blades, brushes or strips can be varied. In the embodiment in FIG. 11, four blades 651 are shown. Furthermore, as shown in FIG. 11, it can be centrally mounted. However, it can also have a floating design, similar to the above-described abrasive bodies, or it can be mounted at the circumference. FIG. 10 shows the course of the suspension during the filtration process in the filter device 600. The suspension is fed through the suspension collection feed line 623 into the individual suspension feed lines 603 (arrow 613), where it enters the interior 610 of the vessel 602. From there it is filtered through the filtering means 606. The filtrate drains off through the filtrate removal line 605, shown by the arrow 615. Unfiltered suspension is fed through the suspension removal lines 604 to the suspension collection removal lines 624, where its central outflow occurs (arrow 614). Solids and particles which may accumulate can be drained off through a particle removal 611 in the vessel bottom 608 (arrow 612). The filter device 600 can also be designed with a modular construction, as described under FIGS. 2 to 4. Furthermore, the surface can be structured, similar to the version in FIG. 6.

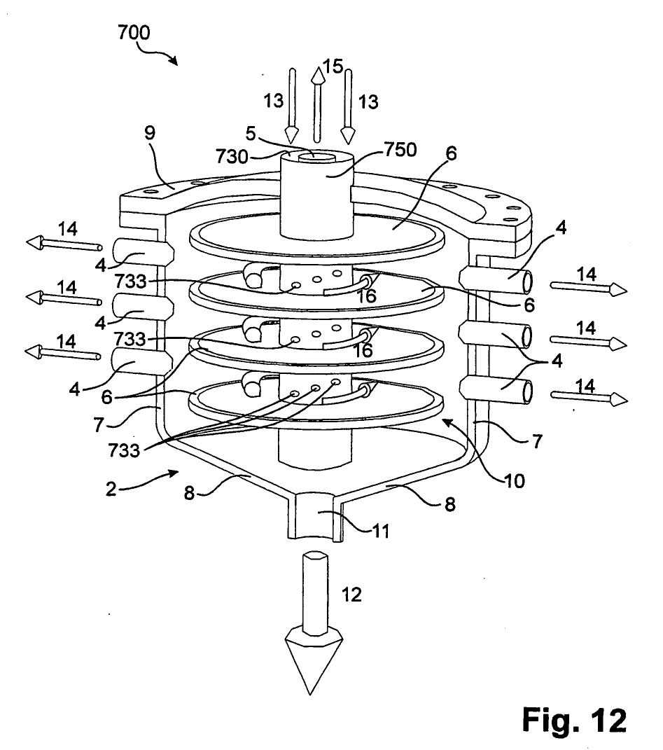

In FIG. 12, another preferred embodiment of the invention is shown. Equivalent parts are therefore provided with the same reference signs as in FIG. 1, so that, in these cases, it is referred to the description there. The inflow of the suspension now does not occur through suspension feed lines in the vessel wall (see reference sign 3 in FIG. 1), but rather through the central tube 750. For this purpose, the latter has a central suspension feed line 730. The suspension is then removed through tangential apertures 733 and put into flow over the filtering means 6. These apertures 733 can be designed as nozzles, in particular in the form of a point nozzle, a flat nozzle or a nozzle with a mobile, in particular rotating, nozzle jet. These apertures or nozzles are also located so that the suspension can be fed tangentially into the vessel interior. Therefore, the longitudinal axis of the nozzles is not perpendicular to the surface, which is parallel to the origin of the nozzle 733 on the suspension feed line 730, but rather at an angle deviating from it. The apertures 733 or nozzles of the suspension feed line 730 are, in other words, obliquely located and orientated. The central tube 750 also houses the filtrate removal line 5. As in the embodiment of FIG. 1, the filtrate removal line 5 is linked to the filtering means 6, so that the filtered suspension, the filtrate, moves from the filtering means 6 into the filtrate removal line and can therefore be drained off from the filter device 1 or 700, respectively. The central tube is designed in a chambered form, has two apertures slid into each other and equipped with corresponding connections, or contains two or more side-by-side tubes, so that both the filtrate output and the suspension input can be performed through this central tube.

Another embodiment of the invention can be explained by means of FIGS. 1 and 12. It is intended that the suspension is supplied from the vessel wall 7, as described under FIG. 1 (reference sign 3). However, the outflow of the suspension now does not occur through the suspension removal lines located in the vessel wall 7, as in FIGS. 1 and 12, but rather through the central tube 750. Instead of the central suspension feed line 730, a central suspension removal line is now provided in the central tube. Accordingly, the central tube of such an embodiment possesses both the filtrate removal line and the suspension removal line in the central tube. It is therefore also designed in a chambered form, has two apertures slid into each other and equipped with corresponding connections, or contains two or more side-by-side tubes, so that both the filtrate output and the suspension output can be performed through this central tube. The apertures 733 then feed the suspension to the central suspension removal line, located in the central tube.

On principle, it can also be entertained to create a filter device in which all of the inflows and outflows are located in the central tube, i.e. both the filtrate removal line and also the suspension feed and removal lines.

Another embodiment of the invention can be explained by means of FIGS. 1 and 12. It is anticipated that a vibration generator, or exciter, is located in the central tube 750. This vibration generator generates vibrations of a specific frequency. Thus the filter device 1 or 700, respectively, is put into vibration. In particular, the filtering means 6 are put into vibration. By the vibration of the filtering means, accumulations are further prevented. As soon as particles are deposited on it, not only will the tangential flow remove them but also the slight vibration of the filtering means, in particular the ceramic hollow filter discs. The vibration generated by the vibration generator can have different frequencies, whereby the frequency with the best cleaning properties can be easily determined by means of experimentation. In particular, it may also lie in the ultrasound range. In experiments with commercially available ceramic hollow filter discs with a diameter of 312 mm, a frequency of approx. 50 Hz emerged as particularly favorable.

Another embodiment of the invention can be explained by means of FIGS. 1 and 12. It is anticipated that, as in filter assemblies known in the state of the art, the filtering means stack performs a rotational movement. This rotational movement can be driven by a motor, firstly. However, the drive can also be achieved by the flow of the suspension. The suspension is fed into the vessel at a particular pressure, for example one bar. A fluid stream arises, which can set a filtering means stack or an individual filtering means into a rotary motion. Through the rotation of the filtering means, shadow formation is further prevented. Each area of a disc of filtering means is therefore always in a favorable alignment to the suspension feed line. Particles which may have been deposited on the surface of the filtering means are therefore always carried away.

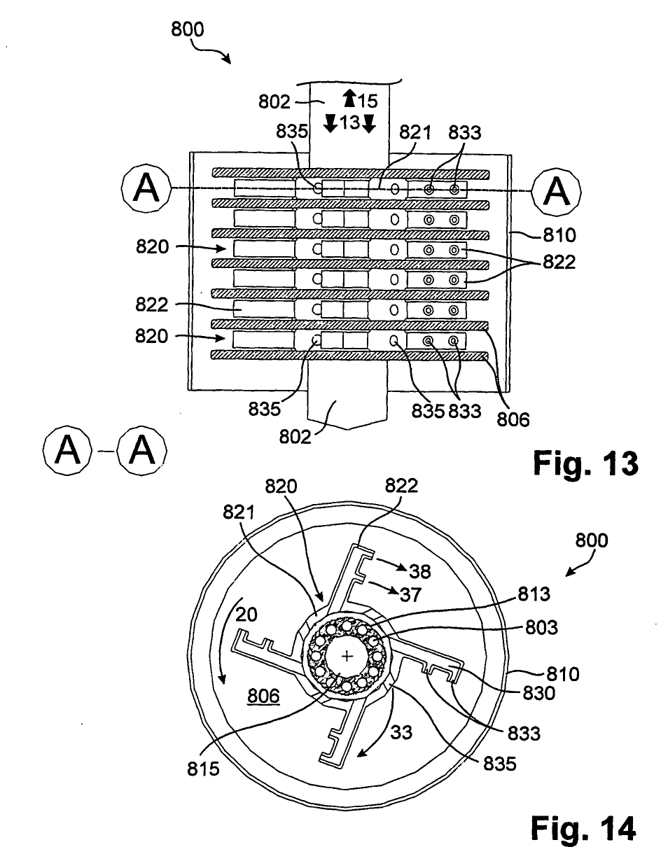

Finally, FIGS. 13 and 14 show yet another embodiment of the invention. The filter device 800 again has a central tube 802, through which the filtrate removal is performed, shown by the arrow 15. The filtrate outflow occurs through filtrate removal lines and the filtrate collection removal line 815. The feed of the suspension occurs through the central tube 802, indicated by the arrows 13. For this purpose, central suspension feed lines 803 with corresponding apertures 813 are provided in the central tube. The suspension thus leaves the central suspension feed line 803 through the apertures 813. However, surrounding the central tube 802 there are now inflow part 820 between the filtering means 806. These consist of a annular bearing 821, which surrounds the central tube 802. However, the ring-shaped bearing 821 is not firmly attached to the central tube 802, but rather it only surrounds it loosely, i.e. the inflow part 820 is rotatable. In addition, it also has prolongations 822, in which the suspension feed line 830 runs. This suspension feed line ends in the apertures 833. Furthermore, apertures 835 can also be provided at the rotatable bearing 821. Further, the suspension leaving the apertures 813 is led with the aid of the inflow part 820. On the one hand, the suspension exits through the apertures 835 and thus flows over the filtering means 806. This is shown by the arrow 33. On the other hand, the suspension enters the suspension feed line 830 and is led over a part of the filtering means 806. The suspension leaves the suspension feed line 830 through the apertures 833, indicated by the arrows 37 and 38. As clearly shown in FIG. 14, the suspension is therewith channeled directly to specific areas of the filtering means 806. By the inflow of the suspension, a rotating movement of the inflow part 820 occurs, whereby the filtering means 806 is uniformly overflowed. This rotating movement of the inflow part 820 is illustrated by the arrow 20. In other words, the inflow parts 820 are devices or elements with which the suspension can be led over the filtering means 806. Suitable for use as such elements, for example, are short line sections or prolongations 822, with apertures 833, which are directed towards the filtering means surface. These lines protrude from the central tube 802 in the direction of the circumference of the filtering means, in the manner of spokes. They are preferably mounted rotatable, whereby, however, the drive for the rotating movement does not result from energy-consuming devices, such as motors, etc., but rather these inflow parts 820 turn themselves, caused by the blowout of the suspension. By the blowout of the suspension a rotational movement of the inflow parts 820 is effected whereby the entire filtering means surface is overflowed over the time und is thereby kept free from residues evenly. As an alternative to the described lines or projections, elements in different shapes with apertures can also be used, whereby the apertures are located so that the suspension is led over the filtering means. Propeller-type, star-shaped or saw blade-like arrangements can be named as an example. The inflow parts can also be provided in addition to the above-mentioned apertures through which the inflow occurs.

Moreover, the filtering means group of the filter device 800 is not directly surrounded by a vessel, for example as in FIG. 1 (see reference sign 2). The filter device 800 thus represents an alternative to the previously described filter devices, each of which have one vessel. In certain application areas, such an embodiment can be advantageous, for example, in areas where filtration must only be performed at negative pressure. The necessary negative pressure can be achieved, for example, with the use of a suction pump. The filter device 800 can then be inserted into a vessel containing the suspension, which vessel can then be regarded as the vessel of the filter device. The filter device 800 is therefore directly in the suspension and is surrounded by it. This design is more cost-effective in comparison to the other designs. Not only is the housing, which surrounds the filtering means group dispensed with, but also the suspension removal lines, since the filter device is located directly in the suspension. This variant of the filter device, according to the invention, is particularly well-suited to filter devices which provide the flow direction from the interior to the circumference of the filtering means, such as for example the filter device 800 in FIGS. 13 and 14. However, a filter device with a reverse flow direction, as shown for example in FIG. 1, can also be designed as such a variant. To achieve this, around the circumference of the filtering means, either a cylindrical double wall is provided, which has apertures that point into the interior of the filtering means group, or suspension feed lines in the form of pipelines are arranged around the filtering means, which also have apertures, through which the suspension is expelled.

Finally, for a longer guidance of the tangential flow around the filtering means group, a guide ring 810 can be provided. This is preferably open at the top and bottom; it is therefore not an element comparable with the vessel 2. The guide ring 810 preferably has the form of a cylindrical wall, as shown in FIG. 14. However, the guide ring can also have other forms. Thus, with the aid of a special shape of the guide ring 810, the suspension can be guided so that eddies and vortices are generated (cyclonic effect). Moreover, it is possible to draw off various phases of the suspension. In a funnel-shaped design of the guide ring 810, light substances, e.g. oils, are collected in the area of the funnel. In a waisted design, i.e. expanded on top and at the bottom and constricted in the middle, lighter substances will be collected on top and substances with a higher density will be collected beneath. Therefore, the solids and suspended matter contained in the suspension, or the other fluids to be separated out, are not only separated from the filtrate, but are also simultaneously fractionated. In addition, the guide ring 810 can also have indentations, corners, edges, etc., similar to the vessel of the filter device 300, by means of which the flow and its direction are changed. Finally, at the top or bottom of the guide ring 810, a cover or floor can also be provided. Thereby the suspension leaves the filter device 800 at the top or bottom of the filter device. Through the narrowing of the outlet, the suspension is possibly accelerated, so that it is vortexed. A cylindrical guide ring 810 causes the suspension to be held for longer periods over the surface of the filtering means 806, since the suspension flow bounces off the wall and is led back onto the filtering means. Therefore, in the described filter device, within the comparatively large volume of a vessel surrounding this, e.g. a container with fluid, a small space is created, the content of which can be kept easily in motion by the flow of the suspension. Thus the cleaning effect is further improved. However, the guide ring 810 can also be dispensed with; the cleaning performance of the vesselless filter device 800 according to the invention is still sufficient to keep the surface of the filtering means 806 free of residues.

For an additional improvement of the filter cake removal, a gas feed pipe can be provided. This can, for example, be identical to an overflow pipe (not shown) provided in vessel 2. Through this gas feed pipe, gas, in particular air, is fed into the interior of the vessel 10. This air feed can be occurred either temporarily, in particular at intervals, or continuously. Through the introduction of air, for example at a slight overpressure, the flow rate increases at a constant pump performance and constant total pressure. Furthermore, turbulences are formed, whereby the filter cake is loosened. The duration of the air entry can be very short; an injection of air in the range of several seconds has already been proven to be sufficient in experiments. However, the air feed can also proceed for longer or even continuous intervals, which ultimately depends on the suspension to be filtered. The minimum amount of air applied in one to several seconds is already sufficient to vortex the deposited particles and bring them into suspension. The water column is vortexed through the bursting and reforming air bubbles. The gas feed pipe can be identical to already available components, for example the overflow pipe, as implemented above. Similarly, it could also, for example, be identical to a suspension feed line. Finally, a separate gas feed pipe can also be used.

In the embodiments, numerous vessel forms have already been illustrated. However, preferably the vessel interior is cylindrical in its basic shape, since this prevents the undesirable deposition of particles. The shapes can deviate from this if, for example, the indentations 330, 340 shown in FIG. 6 are added. Furthermore, other vessel shapes are also considered to be strictly cylindrical, e.g. conical, centrally tapering, or having horizontal circumferential, ring-shaped indentations. These horizontal circumferential indentations are indentations in the vessel wall, in which particles carried to the vessel wall by centrifugal force are collected (cyclonic effect).

The entire filter device can be designed as a fully ceramic filter. This means that all parts can basically be manufactured from ceramics. In customary state of the art filter devices, this was not possible, since at least one part was always rotating, and therefore not to be incorporated as a ceramic part, or only with great difficulty. This results in a number of advantages. The fully ceramic filter device can be sterilized substantially more conveniently or at all, respectively, than in the known devices. Not only can comparatively high temperatures be used, but also more aggressive procedures and disinfectants, which may attack metals, for example. As for the fully ceramic filtering means, the cleaning or regeneration of the fully ceramic filter device is also possible with steam, hot or reactive gases or by means of pyrolysis.

In all of the embodiments shown in the Figs., the filtering means stack was shown such that its axis was vertically located. In other words, the filtering means stack stands in the filter device. However, it is also possible, without reducing the advantageous abrasive removal, to position the stack of filtering means lying, so that its axis runs horizontally or at an angle deviating from the horizontal. An inclined arrangement is advantageous for ventilation processes, for example.

1. Filter device comprising a vessel, at least one suspension feed line and one suspension removal line in each case, at least one filtrate removal line and at least one filtering means disposed in a stationary manner, wherein the at least one suspension feed line is disposed in a wall in the vessel and/or in an interior of the vessel, wherein the at least one suspension feed line is disposed such that a suspension can be supplied to the vessel tangentially and the rotating flow of the suspension which is thus produced over the filtering means prevents the surface thereof from clogging.

2. Filter device according to claim 1, wherein the filtering means is at least one of disc-shaped and a ceramic hollow filter disc.

3. Filter device according to claim 1, wherein the at least one suspension feed line is disposed in the vessel wall and the suspension removal line is disposed in the vessel wall and/or in at least one of the vessel interior and a central tube.

4. Filter device according to claim 1, wherein the at least one suspension feed line and the at least one filtrate removal line are disposed in a central tube which is of multi-part construction.

5. Filter device according to claim 1, wherein a plurality of suspension feed lines and suspension removal lines are associated with each of the at least one filtering means in an approximately uniformly distributed manner, wherein the number of the plurality of suspension feed lines may differ from the number of the plurality of suspension removal lines.

6. Filter device according to claim 5, wherein the plurality of suspension feed lines and/or the plurality of suspension removal lines are disposed at different levels of the vessel.

7. Filter device according to claim 1, wherein the at least one suspension feed line is at least one of a nozzle, a point-type nozzle, a flat nozzle, and a nozzle with at least one of a mobile and a rotating jet and a Venturi nozzle.

8. Filter device according to claim 1, wherein the vessel wall comprises indentations, so that the flowing suspension can be deflected at these, wherein the indentations are rounded.

9. Filter device according to claim 1, wherein the vessel further comprises a central tube having indentations, so that the flowing suspension can be deflected at these, wherein the indentations are rounded.

10. Filter device according to claim 1, wherein the at least one suspension feed line is disposed at a left- and/or right-hand tangent, in particular that both left- and right-hand tangential suspension feed lines are provided in the filter device.

11. Filter device according to claim 1, wherein the suspension removal line is disposed at a left- and/or right-hand tangent, in particular that both left- and right-hand tangential suspension removal lines are provided in the filter device.

12. Filter device according to claim 1, further comprising at least one rotating body, which is in the form of at least one of a disc, ring, ball, pyramid and cuboid and can be moved by the flow of the suspension, is provided between two filtering means.

13. Filter device according to claim 1, further comprising an agitator member, which can be driven by the flow of the suspension, provided between two of the at least one filtering means, wherein the agitator member is in the form of at least one of a blade, a strip and a brush.

14. Filter device according to claim 13, wherein the agitator member is mounted centrally, mounted at the circumference of the vessel or is freely suspended.

15. Filter device according to claim 1, further comprising individual filter modules, wherein each filter module comprises at least one suspension feed line, one suspension removal line, one filtering means and one filtrate removal line in each case, wherein the suspension feed lines and/or the suspension removal lines of tandem-disposed modules can be connected by at least one suspension collection feed line and/or at least one suspension collection removal line.

16. Filter device according to claim 1, further comprising a plurality of filtering means or filtering means packs disposed concentrically about the major axis of the filter vessel, which plurality of filtering means or filtering means packs and can be operated in parallel or sequentially, and/or with different porosities.

17. Filter device according to claim 1, further comprising two vessel compartments, which compartments are separated from one another by a partition comprising perforations, wherein a flow circulation can be produced in each vessel compartment by the suspension flowing into the particular vessel compartment.

18. Filter device according to claim 1, further comprising a central tube which is or comprises a filtrate removal line and/or which is or comprises a suspension feed line and/or which is or comprises a suspension removal line, and that an oscillation generator is disposed in the central tube, wherein the oscillation generator generates an oscillation of 30-80 Hz.

19. Filter device according to claim 18, further comprising at least one inflow part disposed around the central tube between at least two of the at least one filtering means, wherein this comprises an annular bearing and prolongations with a suspension feed line and corresponding openings, so that the suspension can be routed over the surface of the at least one filtering means.

20. Filter device according to claim 1, wherein the vessel can be supplied with gas via a gas supply line, wherein the gas can be supplied temporarily, in at least one of intervals and continuously.

21. Filter device according to claim 1, further comprising a guide ring around the at least one filtering means disposed to form a filtering means pack, wherein transmembrane pressure can be produced by underpressure.

22. Filtering means, comprising an internal base body, via which a filtrate is removed towards a filtrate removal line, and a screen or a membrane, mounted thereabove, through which the filtration process takes place, wherein at least one of a surface and edge of the filtering means is at least partly profiled, wherein if the edge is partly profiled it is in an undulatory manner.

23. Filtering means according to claim 22, wherein the profiling is applied such that a suspension can be directed from a center of the filtering means to the edge of the filtering means.

24. Filtering means according to claim 22, wherein the profiling is applied such that a suspension can be directed from the edge of the filtering means to a center of the filtering means.

25. Filtration method carried out in a filter device, the filter device comprising a vessel comprising at least one suspension feed line and one suspension removal line in each case, at least one filtrate removal line and at least one filtering means disposed in a stationary manner, comprising the step of: allowing a suspension to flow into the filter device tangentially under pressure and through a plurality of uniformly distributed suspension feed lines onto the filtering means.

26. Filtration method according to claim 25, further comprising a backwash step following the allowing step, in which the vessel is supplied via the filtrate removal line with liquid and/or gas, the liquid and/or gas being at least one of the suspension and filtrate.

27. Filtration method according to claim 25, wherein the suspension flows in at varying pressures, in particular that the pressures vary at intervals.

28. Filter device according to claim 20, wherein the gas is air.
